(19) United States
(12) Patent Application Publication
(10) Pub. No.: US 2006/0090642 A1
(43) Pub. Date: May 4, 2006

(54) Construction improvement of the piston valve in compressing pump

(76) Inventors: Chao Fou Hsu, Kaohsiung City (TW); Ying Lin Cai, Guangdong (CN)

Correspondence Address: BACON & THOMAS, PLLC, 625 SLATERS LANE, FOURTH FLOOR, ALEXANDRIA, VA, 22314, US

(21) Appl. No.: 11/258,027

(22) Filed: Oct. 26, 2005

(30) Foreign Application Priority Data
Oct. 27, 2004 (CN) 20041090237X

(51) Int. Cl. F16J 1/00

(52) U.S. Cl. 92/172

(57) ABSTRACT

The present invention relates to a construction improvement of the piston valve in compressing pump with features as below: The discharge base, which is built in the center of the piston valve, is contrived into planar shape; Some discharge spouts are created on said discharge base in corresponding with each said inlet slots; An orientating lump is created in the top center of said discharge base and being punched an orientating hole at its center; The anti-backflow plastic gasket, which is contrived into 3-blade planar shape to entirely cover the top of said discharge base, has a gap cleft created between each blade so that each said blade can closely block exactly each said corresponding inlet slots on said discharge base respectively; During each said wobble wheels of the compressing pump pushing said diaphragm in turns, the water flow, which coming from each said inlet slot at each area, will continuously runs into each said discharge spout at each area in said discharge base by turns so that each blade on said anti-backflow plastic gasket working up-open and down-shut action by turns as well, thus it really achieves the open-and-shut effect of each said discharge spout at each area; Therefore, not only the drawback of leakage and pressure loss or failure can be prevented, but also the serving life of said anti-backflow plastic gasket can be prolonged, thus the compressing and discharging efficiency of integral compressing pump can be further enhanced.

### FIELD OF THE PRESENT INVENTION

The present invention relates to the discharge of the piston valve in compressing pump exclusively used in the reverse osmosis purification; more particularly a construction improvement being contrived to prevent the drawback of said compressing pump from leakage and pressure failure or loss.

### BACKGROUND OF THE PRESENT INVENTION

Refer to FIG. 1 through FIG. 6, a conventional compressing pump exclusively used in the reverse osmosis purification comprises: a motor 10 with an upper hood chassis 11 being built on the output shaft (not shown in the figure) of said motor 10, and multiple screw bores 12 are perforated on the peripheral of said upper hood chassis 11; a plurality of wobble wheels 13, which are movably placed in said upper hood chassis 11, are drived by the output shaft of said motor 10 such that being transformed into radial reciprocating motion; a diaphragm 20 covers on said upper hood chassis 11; a piston valve 30 is embedded in said diaphragm 20; an anti-backflow plastic gasket 40 and an upper hood 50 are closely stuck on said piston valve 30; By means of bolts 2 driving through said multiple screw bores 12 on said upper hood chassis 11 and corresponding perforated bores 51 being preset on said upper hood 50, said conventional compressing pump is assembled (as shown in the FIG. 6).

Wherein, a seal groove 21 is rimed on said diaphragm 20; some convex humps 22, which are respectively set in corresponding with each wobble wheel 13, have some piston pushers 23 are stacked on each top of their own; a perforated bore 231 being punched on each said piston pushers 23 and a perforated bore 221 being punched on each said convex humps 22 are coaxial to be driven by each screw 24 so that each said piston pushers 23 and said diaphragm 20 can be securely screwed on each said wobble wheel 13 (as shown in the FIG. 4), thus each said piston pushers 23 and said diaphragm 20 together with each said wobble wheel 13 can radially reciprocate synchronously (as hypothetical dash line shown in the FIG. 4).

Refer to FIG. 2 and FIG. 4 to FIG. 6, a discharge base 31, which is concaved at the center of said piston valve 30 with bowl-shape direction towards said upper hood 50, has an orientating hole 32 punched at its center; three separating grooves 33 are radially indented around said orientating hole 32 with 120 degree included angle one another; some discharge spouts 34 are punched on the area in between each said groove 33; some inlet slots 35, which are punched around the peripheral of said discharge base 31 in corresponding with each said discharge spouts 34, has some inverse flare piston slice 36 punched at each center of their own so that to block each said corresponding inlet slots 35; Said anti-backflow plastic gasket 40, which is bowl-shape unitary-molded integral resilient soft material, is closely stuck on the top surface of said discharge base 31 in said piston valve 30 with an orientating stem 41 projecting at its bottom center and with three separating rib panels 42 are radially indented at the top around center axis with 120 degree included angle one another; a projecting panel 43 is respectively protruded on the peripheral corresponding to each said rib panel 42; Synchronously inserting said orientating stem 41 into said orientating hole 32 on said discharge base 31 and insetting each said projecting panel 43 into each corresponding said separating groove 33, the entire outer hemispherical surface of said integral anti-backflow plastic gasket 40 can closely stick and block with said discharge spouts 34 on said discharge base 31 (as shown in the FIG. 4); wherein, an inlet chamber 3 is created among said anti-backflow plastic gasket 40 and each said discharge spout 34 on said discharge base 31 as well as each said piston pusher 23 on said diaphragm 20 such that one of its end in connection with said inlet slot 35 (as shown in the FIG. 6).

Said upper hood 50, in which an inlet orifice 52 and an outlet orifice 53 as well as some perforated bores 51 are built on its outer surface (as shown in the FIG. 2 and FIG. 6), has a ramp groove 54 indented on the inner rim of its bottom so that the outer rim of the integral body, which is combined by stacking said diaphragm 20 with said piston valve 30, can be closely stuck with said ramp groove 54; An annular groove 55, which is built in the internal center of said upper hood 50, has its bottom strained against the outer rim of said discharge base 31 on said piston valve 30 so that a compressed chamber 4 is encompassed by the inner wall of said annular groove 55 and discharge base 31 on said piston valve 30 (as shown in the FIG. 6).

Refer to FIG. 7, the tap-water W, which first flows through said inlet orifice 52 on said upper hood 50 and next passes said inlet slot 35 on said piston valve 30, flows into said inlet chamber 3 for being compressed; Under radially reciprocating motion of said to said wobble wheels 13, said piston pushers 23 will simultaneously squeeze the tap-water W in said inlet chamber 3 up to 80 psi˜100 psi; The compressed tap-water W, which is enabled to run into said compressed chamber 4 by way of said discharge spout 34 on said discharge base 31, is discharged out of the compressing pump through said outlet orifice 53 on said upper hood 50, and then flows into filtering membrane tube of the reverse osmosis water purification apparatus for reverse osmosis filtration (not shown in the figures). However, there are some substantial drawbacks in the foregoing procedure as below:

Because said bowl-shaped anti-backflow plastic gasket 40 on said piston valve 30 is contrived to cover each said discharge spout 34 in order to function open-and-shut by turns, the displacement will be limited due to resilience fatigue after the reverse osmosis compressing pump has served for a period of time; hence, it not only affects the discharge efficiency but also the open-and-shut timing; thus, the total discharge efficiency of said compressing pump will be decreased in consequence of reducing shut effect of said anti-backflow plastic gasket 40 corresponding each adjacent said discharge spout 34; the longer aging effect of the compressing pump will increase the more of its distortion δ (as shown in the FIG. 3); eventually, the shut effect of said discharge spout 34 fails entirely, thus the total quantity of the output water and the total output pressure is vitally decreased; that is the main reason why the discharge quantity being decreased and the output pressure being lost or failed after a period in serving time (about 3 months to 6 months) of the conventional compressing pump.

### SUMMARY OF THE PRESENT INVENTION

The primary object of the present invention is to provide a construction improvement of the piston valve in compressing pump, wherein, The discharge base, which is built in the center of the piston valve, is contrived into planar shape; The anti-backflow plastic gasket, which is contrived into 3-blade planar shape to entirely cover said discharge base, has a gap cleft created between each blade so that each said blade can closely block exactly each corresponding inlet slots on said discharge base respectively; By means of gap cleft created between each blade, each said blade is flexibly enable to act smoothly during the procedure of constantly alternate open-and-shut discharge without any interference each other; the drawback of leakage and pressure loss or failure can be avoided as the distortion of each said blade will never happen again; thus not only the serving life of said anti-backflow plastic gasket can be prolonged, but also the compressing and discharging efficiency of integral compressing pump can be further enhanced.

### BRIEF DESCRIPTION OF THE DRAWINGS

FIG. 1 is an exploded perspective view of conventional compressing pump.

FIG. 2 is an exploded perspective view of the conventional piston valve and anti-backflow plastic gasket.

FIG. 3 is a perspective illustrative view of the conventional anti-backflow plastic gasket in distortion.

FIG. 4 is an exploded sectional view of the conventional piston valve and anti-backflow plastic gasket.

FIG. 5 is a sectional view in assembly of the conventional piston valve and anti-backflow plastic gasket.

FIG. 6 is a partial sectional view in assembly of the conventional piston valve and upper hood.

FIG. 7 is the functional view of the FIG. 6.

FIG. 8 is an exploded perspective view of the present invention.

FIG. 9 is an exploded sectional view of the present invention.

FIG. 10 is a sectional view in assembly of the present invention.

FIG. 11 is a partial sectional view in assembly of the present invention and upper hood.

FIG. 12 is the functional view of the FIG. 11.

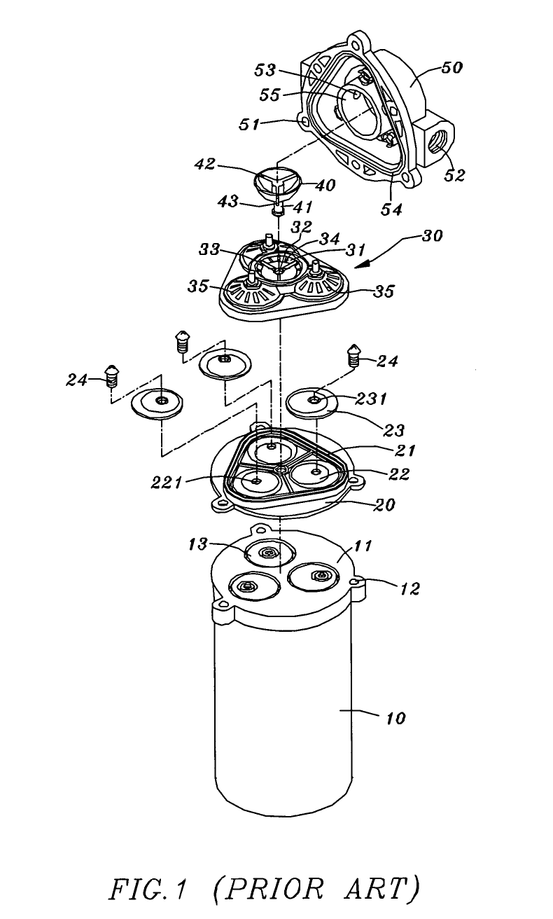

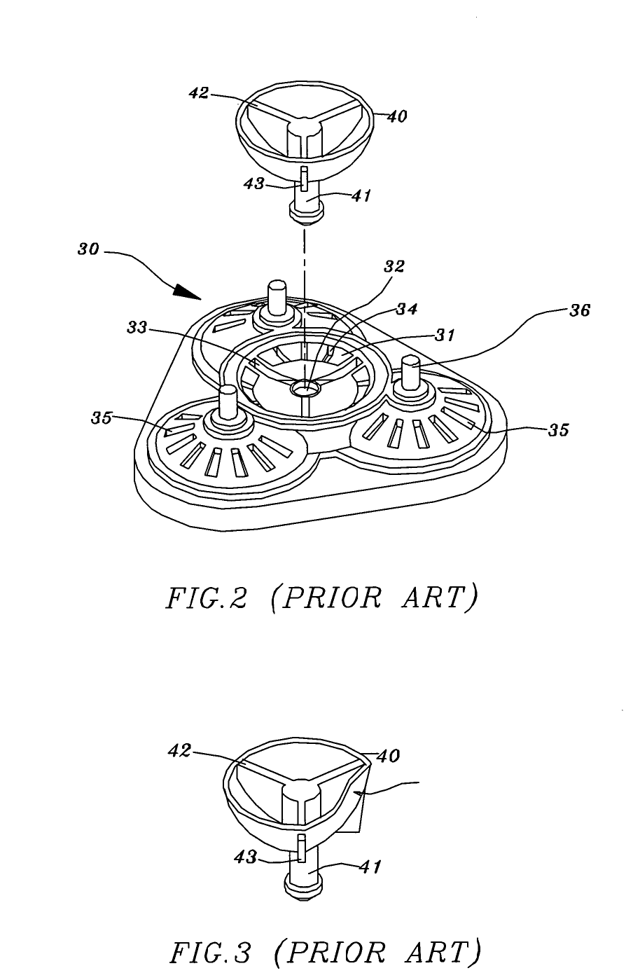

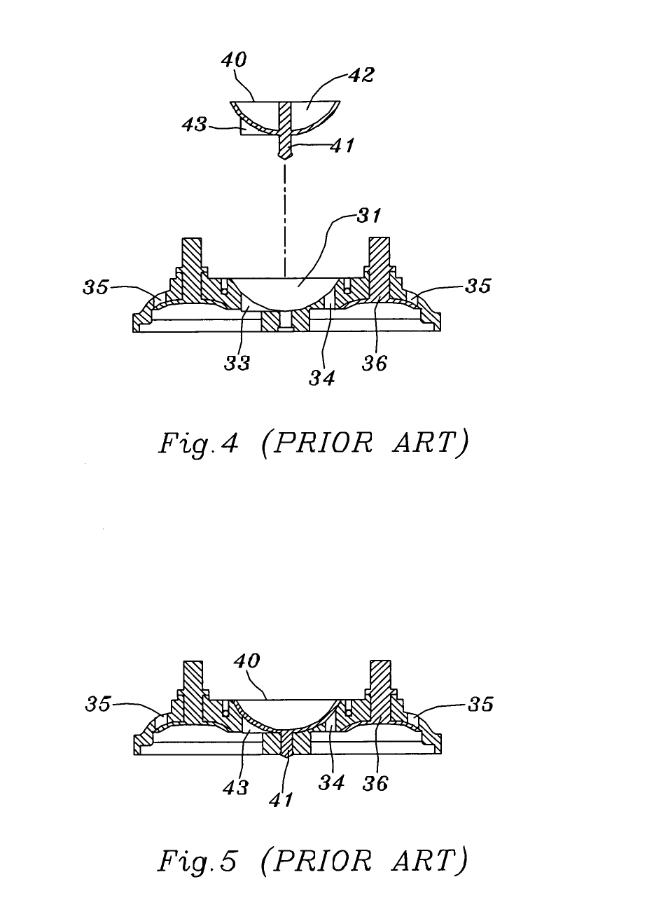

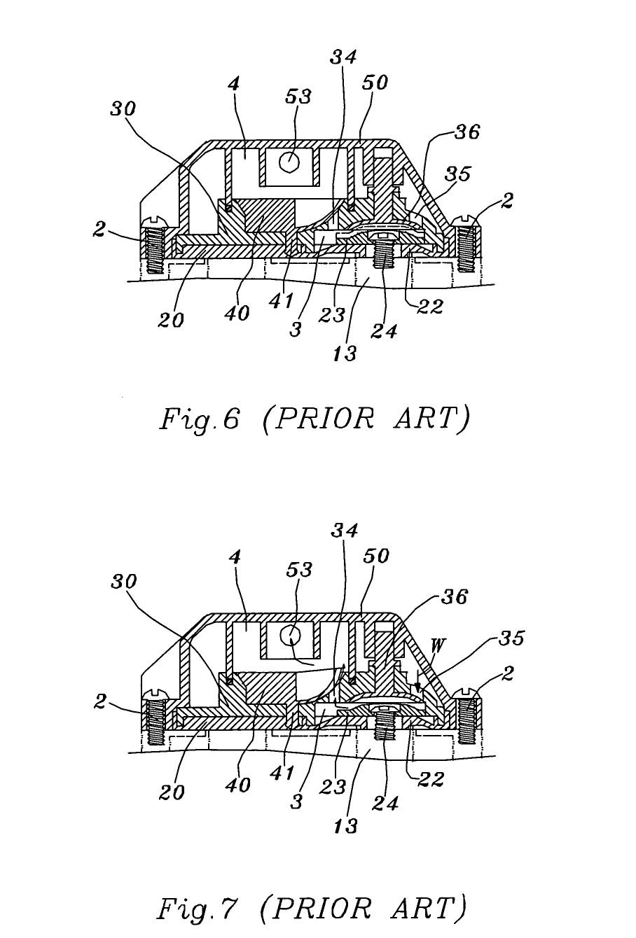

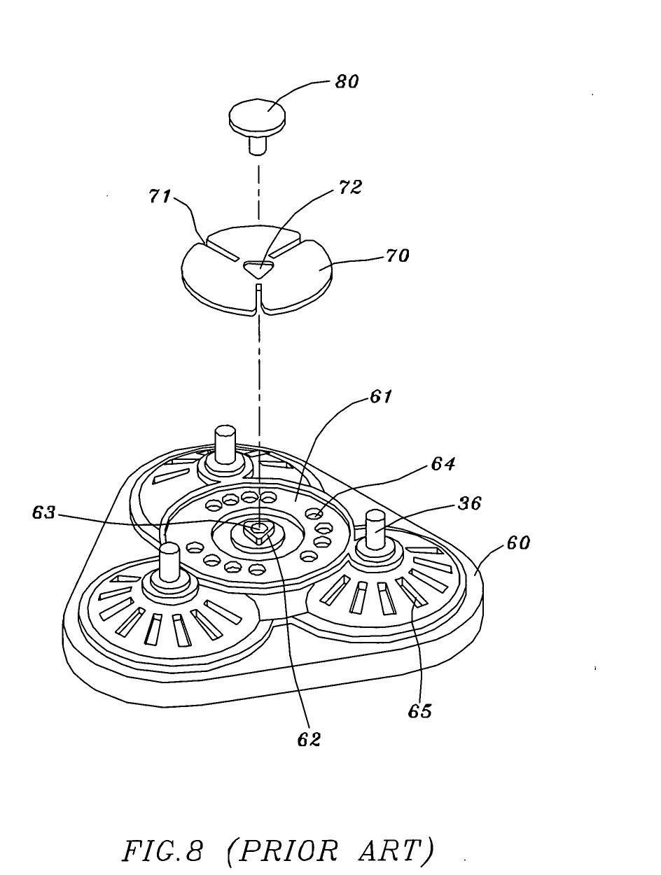

### DETAILED DESCRIPTION OF THE PREFERRED EMBODIMENTS

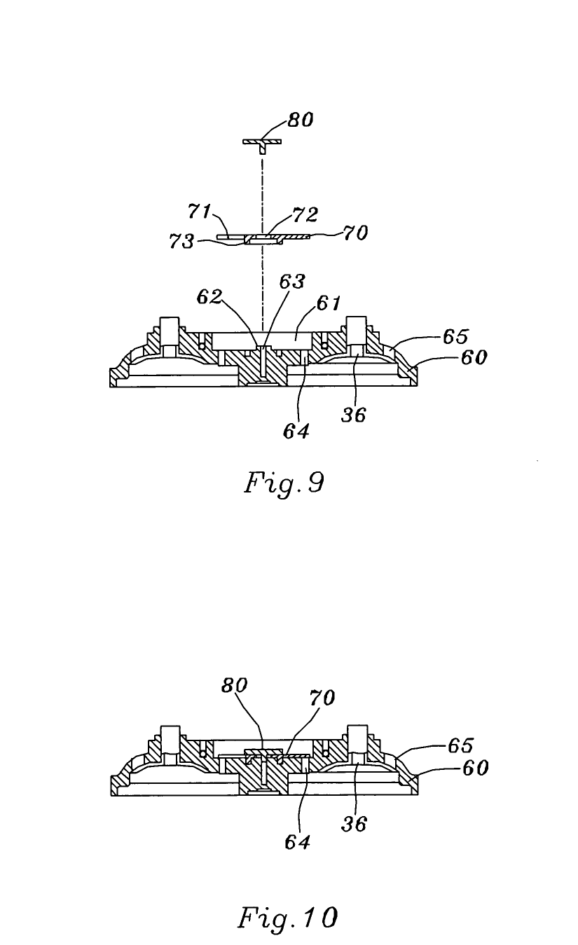

Referring to FIG. 8 to FIG. 10, a construction improvement of the piston valve in compressing pump of the present invention comprising a piston valve and a anti-backflow plastic gasket, Wherein the discharge base 61, which is built in the center of the piston valve 60 of the compressing pump with direction towards the upper hood 50, is contrived into planar shape; An orientating lump 62, which is created in the top center of said discharge base 61 and being punched an orientating hole 63 at its center, has some discharge spouts 64 punched in each of three areas with 120 degree of included angle around itself; Some inlet slots 65, which are created on the peripheral of said discharge base 61 in corresponding with each said discharge spouts 64, has some inverse flare piston slice 36 punched at each center of their own so that to block each said corresponding inlet slots 65; The anti-backflow plastic gasket 70, which is contrived into 3-blade planar shape to entirely cover said discharge base 61, has a gap cleft 71 created between each blade so that each said blade can closely block exactly each said corresponding inlet slots 65 on said discharge base 61 respectively; An orientating aperture 72, which is punched at the center of said anti-backflow plastic gasket 70, has an orientating ring 73 being downwards protruded at its bottom; The assembly procedure is as below: By aligning said orientating ring 73 on said anti-backflow plastic gasket 70 with said discharge base 61, sleeve said orientating aperture 72 with said orientating lump 62 on the center of said discharge base 61 in said piston valve 60; then insert the tack-typed orientating shaft 80 into said orientating hole 63 on said orientating lump 62, thus the rigging assembly of said anti-backflow plastic gasket 70 and said piston valve 60 is properly accomplished.

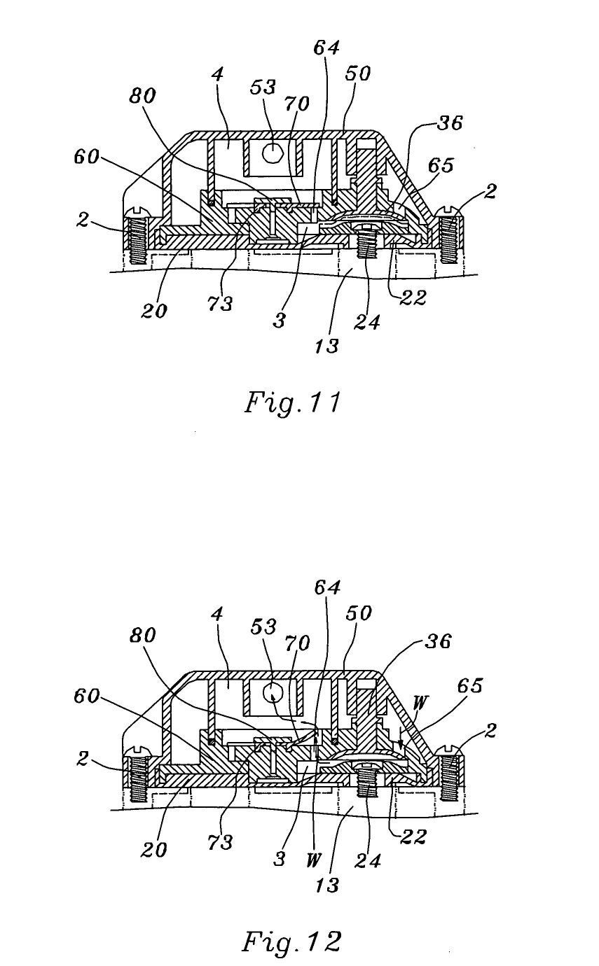

Referring to FIG. 11 and FIG. 12, during each said wobble wheels 13 of the compressing pump pushing said diaphragm 20 in turns, the operation proceeds as below: the tap-water W, which first flows through said inlet orifice 52 on said upper hood 50 and next passes said inlet slot 65 on said piston valve 60, flows into said inlet chamber 3 for being compressed; Under radially reciprocating motion of said to said wobble wheels 13, said piston pushers 23 will simultaneously squeeze the tap-water W in said inlet chamber 3 up to 80 psi˜100 psi; The compressed tap-water W can flush through each blade on said anti-backflow plastic gasket 70 then flow into said compressed chamber 4 by way of said discharge spout 64 and being discharged out of the compressing pump through said outlet orifice 53 on said upper hood 50; Hence, the water flow, which coming from each said inlet slot 65 at each area, will continuously runs into each said discharge spout 64 at each area in said discharge base 61 by turns so that each blade on said anti-backflow plastic gasket 70 working up-open and down-shut action by turns as well, thus it really achieves the open-and-shut effect of each said discharge spout 64 at each area; Therefore, not only the drawback of leakage and pressure loss or failure can be prevented, but also the serving life of said anti-backflow plastic gasket 70 can be prolonged, thus the compressing and discharging efficiency of integral compressing pump can be further enhanced.

What is claimed is:

1. A construction improvement of the piston valve in compressing pump, comprises a piston valve and a anti-backflow plastic gasket; wherein a discharge base, which is built in the center of the piston valve of the compressing pump with direction towards the upper hood, is contrived into planar shape; An orientating lump, which is created in the top center of said discharge base and being punched an orientating hole at its center, has some discharge spouts punched in each of three areas with 120 degree of included angle around itself; Some inlet slots, which are created on the peripheral of said discharge base in corresponding with each said discharge spouts, has some inverse flare piston slice punched at each center of their own; The anti-backflow plastic gasket, which is contrived into 3-blade planar shape to entirely cover the top of said discharge base, has a gap cleft created between each blade so that each said blade can closely block exactly each said corresponding inlet slots on said discharge base respectively; An orientating aperture, which is punched at the center of said anti-backflow plastic gasket, has an orientating ring being downwards protruded at its bottom; By aligning said orientating ring on said anti-backflow plastic gasket with said discharge base, sleeve said orientating aperture with said orientating lump on the center of said discharge base in said piston valve; then insert the tack-typed orientating shaft into said orientating hole on said orientating lump, thus said anti-backflow plastic gasket and said piston valve can be securely assembled.
